(19) United States
(12) Patent Application Publication
(10) Pub. No.: US 2017/0146340 A1
(43) Pub. Date: May 25, 2017

(54) ROTATION ANGLE MEASUREMENT MARKS AND METHODS OF MEASURING ROTATION ANGLE AND TRACING COORDINATES USING THE SAME

(71) Applicant: Samsung Electronics Co., Ltd., Suwon-si (KR)

(72) Inventors: Doyoung Yoon, Seoul (KR); Hyungsuk Cho, Hwaseong-si (KR)

(21) Appl. No.: 15/209,137

(22) Filed: Jul. 13, 2016

(30) Foreign Application Priority Data
Nov. 19, 2015 (KR) 10-2015-0162574

(51) Int. Cl. G01B 11/27

(52) U.S. Cl. CPC G01B 11/272

(57) ABSTRACT

An alignment key pattern includes an origin alignment mark having a cross shape and a rotation angle measurement mark (RAMM) having a radial shape. The RAMM includes a plurality of radially-extending bars that are aligned to a common center point. These radially-extending bars include at least two horizontal bars, which extend horizontally and are spaced apart from each other, a vertical bar configured to be perpendicular to and spaced apart from the horizontal bars, and diagonal bars configured to have a first angle with respect to and be spaced apart from the horizontal bars and the vertical bar.

### REFERENCE TO PRIORITY APPLICATION

This application claims priority under 35 U.S.C. §119 to Korean Patent Application No. 10-2015-0162574, filed Nov. 19, 2015, the disclosure of which is hereby incorporated herein by reference in its entirety.

### BACKGROUND

Embodiments of the inventive concept relate to a rotation angle measurement mark used to measure a rotation angle of a wafer, and methods of measuring a rotation angle and tracing coordinates using the rotation angle measurement mark.

After forming patterns on a wafer, and before performing various measurement and possibly other fabrication processes, operations are performed to determine whether the wafer is precisely aligned with a stage of a measurement apparatus. For example, a first process for measuring and calibrating a coordinate offset value to match a zero point or an origin point of the stage with those of chip patterns on the wafer is performed. A second process for determining whether the chip patterns on the wafer are tilted, twisted or rotated with respect to the stage, measuring a rotation angle of the reference line, and compensating for the rotation angle is performed. The second process includes measuring at least two separate alignment marks for measurement. That is, the second process includes measuring a first alignment mark, moving the stage, measuring a second alignment mark, and calculating a rotation angle from the result of measuring the first alignment mark and the second alignment mark. The inventive concept proposes shapes of an alignment key pattern and a rotation angle measurement mark in which the second process is finished by a single performing of the measuring the alignment mark without moving the stage. Further, the inventive concept proposes methods of measuring a rotation angle and tracing coordinates on a wafer using the rotation angle measurement mark.

### SUMMARY

Some embodiments of the inventive concept provide a rotation angle measurement mark used to measure a rotation angle.

Some embodiments of the inventive concept provide an alignment key pattern having an origin alignment mark and a rotation angle measurement mark.

Some embodiments of the inventive concept provide a method of measuring a rotation angle using the rotation angle measurement mark.

Some embodiments of the inventive concept provide a method of tracing coordinates on a wafer using the rotation angle measurement mark.

Some embodiments of the inventive concept provide a method of measuring patterns on the wafer having coordinates traced using the rotation angle measurement mark.

In accordance with an embodiment of the inventive concept, an alignment key pattern includes an origin alignment mark having a cross shape and a rotation angle measurement mark (RAMM) having a radial shape. In some of these embodiments of the inventive concept, an alignment key pattern includes: (i) a first horizontal bar and a second horizontal bar disposed on the same virtual line and spaced apart from each other, (ii) a vertical bar configured to be perpendicular to and spaced apart from the first horizontal bar and the second horizontal bar, (iii) a first diagonal bar disposed between the first horizontal bar and the vertical bar to have a first angle with respect to the first horizontal bar (and spaced apart from the first horizontal bar and the vertical bar) and (iv) a second diagonal bar disposed between the second horizontal bar and the vertical bar to have a second angle with respect to the second horizontal bar (and spaced apart from the second horizontal bar and the vertical bar).

According to additional embodiments of the inventive concept, a substrate is provided with an alignment key pattern disposed adjacent to one corner of a rectangle region. The alignment key pattern includes a rotation angle measurement mark (RAMM) having a plurality of bars arranged in a radial shape.

According to additional embodiments of the inventive concept, an alignment key pattern includes an origin alignment mark and a rotation angle measurement mark (RAMM) adjacent to each other. The origin alignment mark includes orthogonally intersected bars and rotation angle measurement mark (RAMM) includes a horizontal bar, a vertical bar perpendicular to the horizontal bar, and a diagonal bar having a first angle with respect to the horizontal bar and the vertical bar.

According to further embodiments of the inventive concepts, methods of measuring an angle of rotation of a substrate include capturing an image of a rotation angle measurement mark (RAMM) located on a semiconductor wafer and then extracting edges of the RAMM into a pixel level image containing pixels therein. Operations are also performed to extract edges of the RAMM into a sub-pixel level image containing sub-pixels therein. Then, regression lines that pass adjacent the sub-pixels are extracted using coordinates of sub-pixels through which the edges extracted into the sub-pixel level image pass. These operations are followed by measuring individual error angles of the regression lines, and determining a representative error angle from the measured error angles.

According to some of these embodiments of the invention, the operations to extract edges of the RAMM into a pixel level image include extracting edges of bars within the RAMM by determining a first derivative of a contrast gradient associated with the captured image of the RAMM. Furthermore, the operations to extract edges of the RAMM into a sub-pixel level image include determining a second derivative of the extracting edges of the bars within the RAMM. The operations to extract regression lines may include extracting regression lines that pass adjacent the sub-pixels using a least square method (LSM). In addition, the operations associated with measuring individual error angles of the regression lines can include measuring respective horizontal angles of the regression lines from a horizontal line of a cross reference line and determining individual horizontal error angles by subtracting reference angle values from the measured horizontal angles.

Detailed items of the other embodiments of the inventive concept are included in the detailed descriptions and the accompanying drawings.

### BRIEF DESCRIPTION OF THE DRAWINGS

The foregoing and other features and advantages of the inventive concepts will be apparent from the more particular description of preferred embodiments of the inventive concepts, as illustrated in the accompanying drawings in which like reference numerals denote the same respective parts throughout the different views. The drawings are not necessarily to scale, emphasis instead being placed upon illustrating the principles of the inventive concepts. In the drawings:

FIG. 1A is a top view of a photomask according to various embodiments of the inventive concept, and FIG. 1B is a top view of a wafer;

FIG. 2 is a top view conceptually illustrating an alignment key pattern according to an embodiment of the inventive concept;

FIGS. 3 to 5 are top views conceptually illustrating rotation angle measurement marks according to various embodiments of the inventive concept;

FIG. 6 is a flowchart for conceptually describing a method of measuring a rotation angle according to an embodiment of the inventive concept;

FIGS. 7A to 7M are schematic views for conceptually describing a method of measuring a rotation angle;

FIG. 8 is a flowchart for conceptually describing a method of tracing coordinates according to an embodiment of the inventive concept;

FIGS. 9A to 9C are schematic views for conceptually describing a method of tracing coordinates on a wafer using a rotation angle or an error angle; and

FIG. 10 is a flowchart for conceptually describing a method of measuring a pattern according to an embodiment of the inventive concept.

### DETAILED DESCRIPTION OF THE EMBODIMENTS

Advantages and features of the inventive concept and methods of achieving them will be made apparent with reference to the accompanying figures and the embodiments to be described below in detail. However, the inventive concept should not be limited to the embodiments set forth herein and may be construed as various embodiments in different forms. Rather, these embodiments are provided so that disclosure of the inventive concept is thorough and complete, and fully conveys the inventive concept to those of ordinary skill in the art. The inventive concept is defined by the appended claims.

The terminology used herein is only intended to describe embodiments of the present inventive concept and not intended to limit the scope of the present inventive concept. As used herein, the singular forms “a,” “an,” and “the” are intended to include the plural forms as well, unless specifically indicated otherwise. The terms “comprises” and/or “comprising” that are used herein specify the presence of mentioned elements, steps, operations, and/or devices, but do not preclude the presence or addition of one or more of other elements, steps, operations, and/or devices.

Further, like numbers refer to like elements throughout the entire text herein. Thus, the same or similar numbers may be described with reference to other figures even if those numbers are neither mentioned nor described in the corresponding figures. Further, elements that are not denoted by reference numbers may be described with reference to other figures.

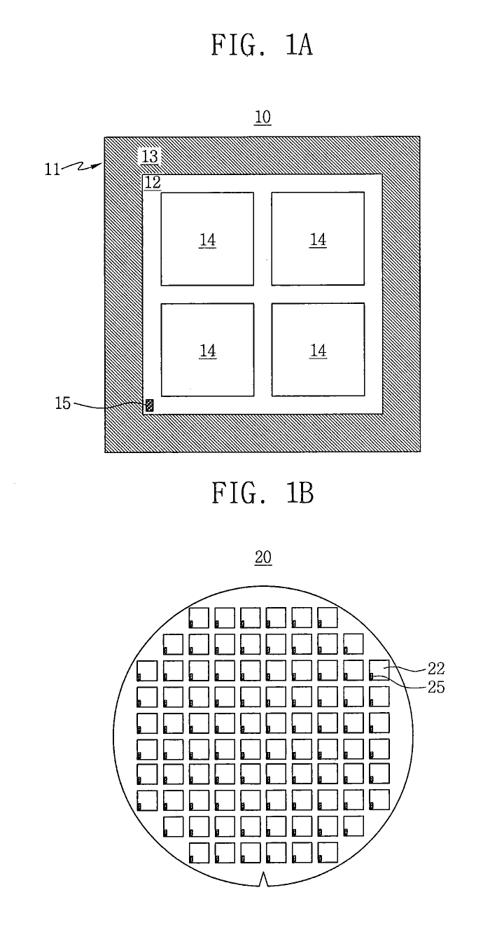

FIG. 1A is a top view of a photomask 10 according to various embodiments of the inventive concept and FIG. 1B is a top view of a wafer 20. Referring to FIG. 1A, the photomask 10 according to an embodiment of the inventive concept may include optical pattern regions 14 and optical alignment key patterns 15 which are disposed in a shot region 12 on a photomask substrate 11. The photomask substrate 11 may include a transparent substrate formed of quartz, or a metal substrate that has a reflective layer in which molybdenum (Mo) and silicon (Si) are alternately stacked. The shot region 12 may be defined as being surrounded by a blind region 13. The shot region 12 may be a region optically exposed by one photolithography process. Further, the shot region 12 may be a region in which optical patterns are formed on the photomask substrate 11. For example, the shot region 12 may be optically transparent and the blind region 13 may be optically opaque. Further, the shot region 12 may reflect light and the blind region 13 may absorb light.

The optical pattern regions 14 may be blocks which form a chip or may each be a chip region. For example, when the shot region 12 corresponds to a semiconductor chip, the optical pattern regions 14 may be functional blocks inside the semiconductor chip. Or when the shot region 12 corresponds to a plurality of semiconductor chips—for example, four semiconductor chips—each of the optical pattern regions 14 may be a semiconductor chip. The optical alignment key patterns 15 may be disposed adjacent to one of four corners in the shot region 12, for example, a lower left corner. The optical alignment key patterns 15 may be used to align the photomask 10 so that the shot region 12 is precisely aligned.

Referring to 1B, the wafer 20 according to an embodiment of the inventive concept may include a plurality of chip regions 22. The chip regions 22 may each correspond to the shot region 12 of the photomask 10. The chip regions 22 may each include an alignment key pattern 25 disposed on one corner in the chip region 22. In the embodiment, the alignment key pattern 25 may be considered as being disposed in a lower left corner of the chip region 22. The alignment key patterns 25 may be formed by optically transferring the optical alignment key patterns 15 of the photomask 10.

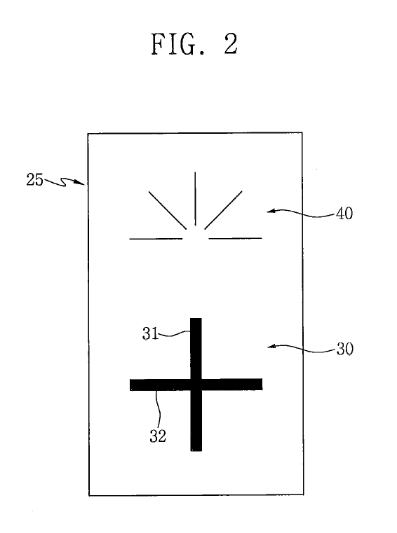

FIG. 2 is a top view conceptually illustrating an alignment key pattern according to an embodiment of the inventive concept. Referring to FIG. 2, the alignment key pattern 25 according to an embodiment of the inventive concept may include an origin alignment mark 30 and a rotation angle measurement mark (RAMM) 40. The origin alignment mark 30 and the rotation angle measurement mark 40 may be disposed adjacent to each other so that optical images of two marks 30 and 40 are obtained by capturing an image in one shot. In some embodiments, when the alignment key pattern 25 is disposed on an upper left corner, an upper right corner or a lower right corner of the shot region 12 or the chip region 22, the locations of the origin alignment mark 30 and the rotation angle measurement mark 40 may be interchanged or may be horizontally disposed. For example, the origin alignment mark 30 may be disposed closer to corners of the shot region 12 than the rotation angle measurement mark 40.

The origin alignment mark 30 may be referenced to align a reference coordinate of the shot region 12 and/or the chip region 22. In particular, the origin alignment mark 30 may denote reference coordinates (0, 0). The origin alignment mark 30 may have a cross shape. For example, the origin alignment mark 30 may include a horizontal bar 31 and a vertical bar 32 which are orthogonal to each other. The rotation angle measurement mark 40 may be used to measure a rotation error of the wafer 20. The rotation angle measurement mark 40 will be described below in detail.

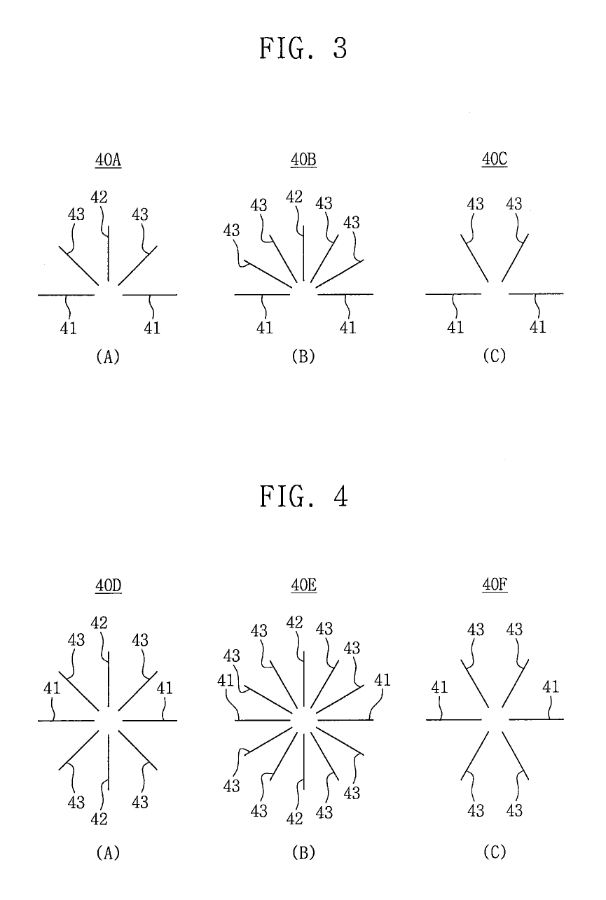

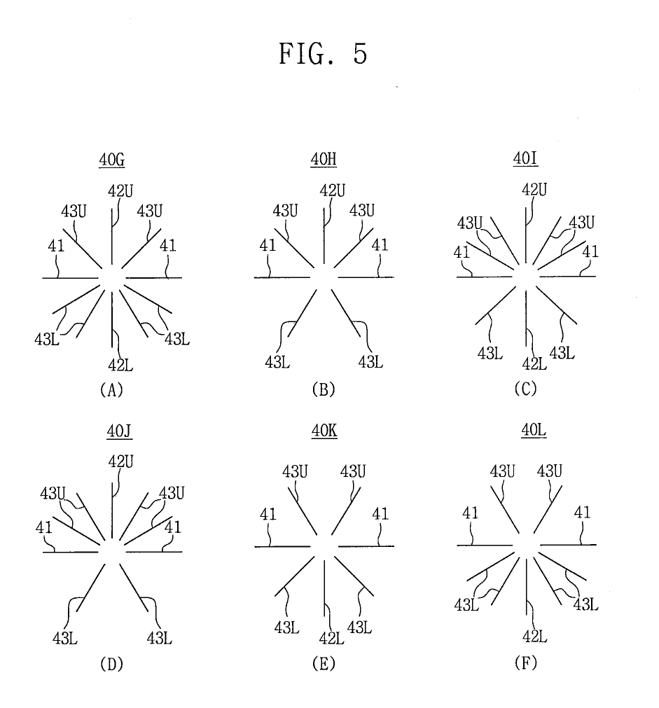

FIGS. 3 to 5 are top views conceptually illustrating rotation angle measurement marks 40A to 40L according to various embodiments of the inventive concept. Examples (A) to (C) of FIG. 3 show a plurality of bars 41 to 43 disposed in half-circular regions to have various angles. Examples (A) to (C) of FIG. 4 show a plurality of bars 41 to 43 disposed in circular regions to have various angles. Examples (A) to (C) of FIG. 5 show a plurality of bars 41 to 43 each disposed to have a different angle in an upper half-circular region and a lower half-circular region.

Referring to FIG. 3, the rotation angle measurement marks 40A to 40C according to various embodiments of the inventive concept may include the plurality of bars 41 to 43 disposed in a radial shape. The rotation angle measurement marks 40A to 40C may have a shape similar to a protractor. In particular, the rotation angle measurement marks 40A to 40C may have bars 41 to 43 arranged to have a shape of half-circular radial lines or half-circular spokes to measure an azimuth or a rotation angle. For example, the rotation angle measurement marks 40A to 40C may include horizontal bars 41 horizontally extending, a vertical bar 42 vertically extending and diagonal bars 43 diagonally extending, which are disposed in half-circular regions. The horizontal bars 41 may be disposed on the same virtual line. The horizontal bars 41 may be spaced apart from each other. The vertical bar 42 may be perpendicular to the horizontal bars 41. The vertical bar 42 may be spaced apart from each of the horizontal bars 41.

The diagonal bars 43 may be disposed between the horizontal bars 41 and the vertical bar 42. In addition, the diagonal bars 43 may also each be spaced apart from the horizontal bars 41 and the vertical bar 42. The diagonal bars 43 may be disposed to have angles that are in the range between 0° and 90° with respect to the horizontal bars 41 and/or the vertical bar 42. In various embodiments of the inventive concept, the diagonal bars 43 may be disposed to have one of specific angles in which 180° (π) is divided by an integer, for example, 10° (π/18), 15° (π/12), 30° (π/6), 45° (π/4), 60° (π/3), and/or the like.

Virtual extending lines of the horizontal bars 41, the vertical bar 42, and the diagonal bars 43 may intersect at one point. For example, the horizontal bars 41, the vertical bar 42, and the diagonal bars 43 may be disposed to extend radially from one point.

The horizontal bars 41, the vertical bar 42, and the diagonal bars 43 may be formed to have a thin and long shape close to a minimum resolution with which a photolithography apparatus, an image obtaining apparatus, a measurement apparatus, and an analysis equipment may be able to recognize an image. For example, in the embodiment, the horizontal bars 41, the vertical bar 42, and the diagonal bars 43 may each be disposed and formed to have a thickness of about 0.5 μm and a length of about 5 μm. In the case of using an apparatus having a higher resolution, the thickness may be smaller and the length may be smaller.

Referring to example (A) of FIG. 3, the rotation angle measurement mark 40A according to an embodiment of the inventive concept may include the diagonal bars 43 which are each disposed to have a 45° angle (π/4) with respect to the horizontal bars 41 and/or the vertical bar 42. Referring to example (B) of FIG. 3, the rotation angle measurement mark 40B according to an embodiment of the inventive concept may include a plurality of diagonal bars 43 which are disposed to have a 30° angle (π/6) or a 60° angle (π/3) with respect to the horizontal bars 41 and/or the vertical bar 42. Referring to example (C) of FIG. 3, the rotation angle measurement mark 40C according to an embodiment of the inventive concept may include a plurality of diagonal bars 43 which are disposed to have a 60° angle (π/3) with respect to the horizontal bars 41. In various embodiments, the horizontal bars 41, the vertical bar 42, and the diagonal bars 43 may be disposed to not only have the special angles described above but also have various angles.

Referring to FIG. 4, rotation angle measurement marks 40D to 40F according to various embodiment of the inventive concept may have a shape similar to a radial or circular protractor. In detail, bars 41 to 42 of the rotation angle measurement marks 40D to 40F may have horizontal bars 41, vertical bars 42, and diagonal bars 43 which are disposed in the circular region to have a radial or spoke shape. In particular, referring to example (A) of FIG. 4, the horizontal bars 41, the vertical bars 42 and the diagonal bars 43 may each be disposed to have a 45° angle (π/4) with respect to adjacent the bars 41 to 43. Referring to example (B) of FIG. 4, the horizontal bars 41, the vertical bars 42 and the diagonal bars 43 may each be disposed to have a 30° angle (π/6) with respect to adjacent the bars 41 to 43. Referring to example (C) of FIG. 4, the horizontal bars 41 and the diagonal bars 43 may each be disposed to have a 60° angle (π/3) with respect to adjacent the bars 41 and 43.

Referring, to FIG. 5, the rotation angle measurement marks 40G to 40L according to various embodiments of the inventive concept may include a plurality of bars 41, 42U, 42L, 43U, 43L which are each disposed to have a different angle in an upper half-circular region and a lower half-circular region to thereby achieve a high level of upper and lower asymmetry. For example, the rotation angle measurement marks 40G to 40L may include horizontal bars 41, upper bars 42U and 43U disposed in the upper half-circular region, and lower bars 42L and 43L disposed in the lower half-circular region. The angle between two of the bars 41, 42U, and 43U which are disposed in the upper half-circular region may be different form the angle between two of the bars 41, 42L, and 43L which are disposed in the lower half-circular region.

Referring to example (A) of FIG. 5, the horizontal bars 41 and the upper bars 42U and 43U may be disposed to have a 45° angle (π/4) therebetween, and the horizontal bars 41 and the lower bars 42L and 43L may be disposed to have a 30° angle (π/60) therebetween. Referring to example (B) of FIG. 5, the horizontal bars 41 and the upper bars 42U and 43U may be disposed to have a 45° angle (π/4) therebetween, and the horizontal bars 41 and the lower bars 42L and 43L may be disposed to have a 60° angle (π/3) therebetween. Referring to example (C) of FIG. 5, the horizontal bars 41 and the upper bars 42U and 43U may be disposed to have a 30° angle (π/6) therebetween, and the horizontal bars 41 and the lower bars 42L and 43L may be disposed to have a 45° angle (π/4) therebetween. Referring to example (D) of FIG. 5, the horizontal bars 41 and the upper bars 42U and 43U may be disposed to have a 30° angle (π/6) therebetween, and the horizontal bars 41 and the lower bars 42L and 43L may be disposed to have a 60° angle (π/3) therebetween. Referring to example (E) of FIG. 5, the horizontal bars 41 and the upper bars 42U and 43U may be disposed to have a 60° angle (π/3) therebetween, and the horizontal bars 41 and the lower bars 42L and 43L may be disposed to have a 45° angle (π/4) therebetween. Referring to example (F) of FIG. 5, the horizontal bars 41 and the upper bars 42U and 43U may be disposed to have a 60° angle (π/3) therebetween, and the horizontal bars 41 and the lower bars 42L and 43L may be disposed to have a 30° angle (π/6) therebetween.

According to an aspect of the inventive concept with reference to FIGS. 3 to 5, it should be understood that the rotation angle measurement marks 40A to 40L may include the plurality of bars 41 to 43 which have further various angles and combinations.

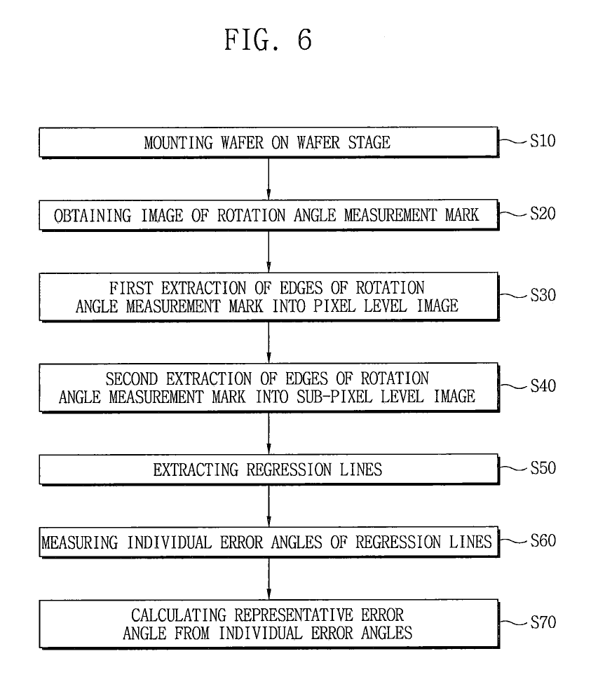

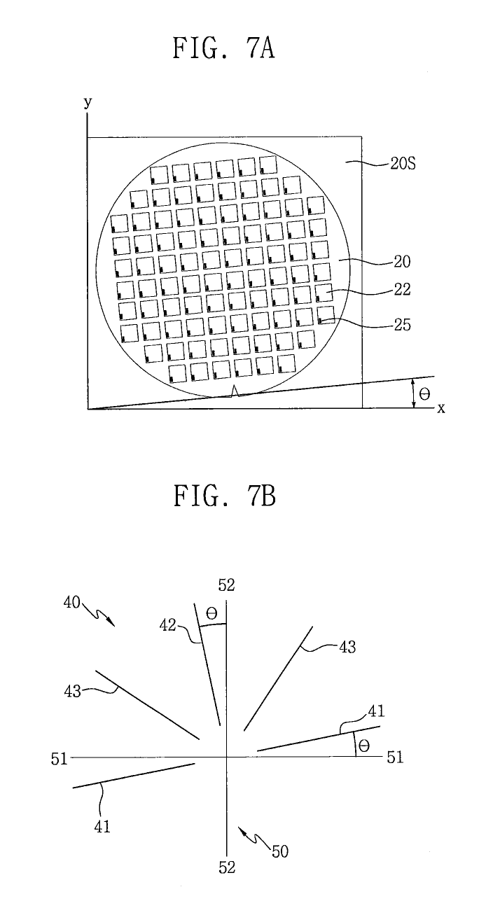

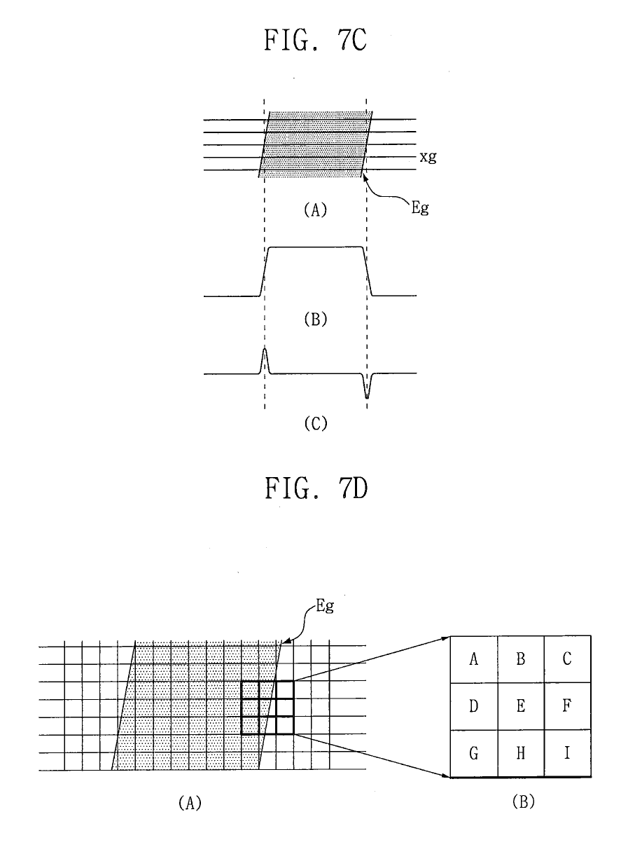

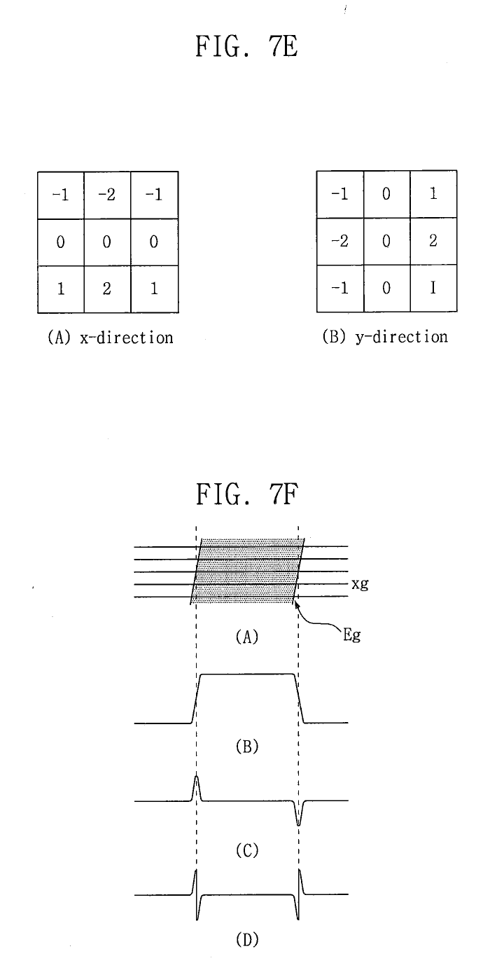

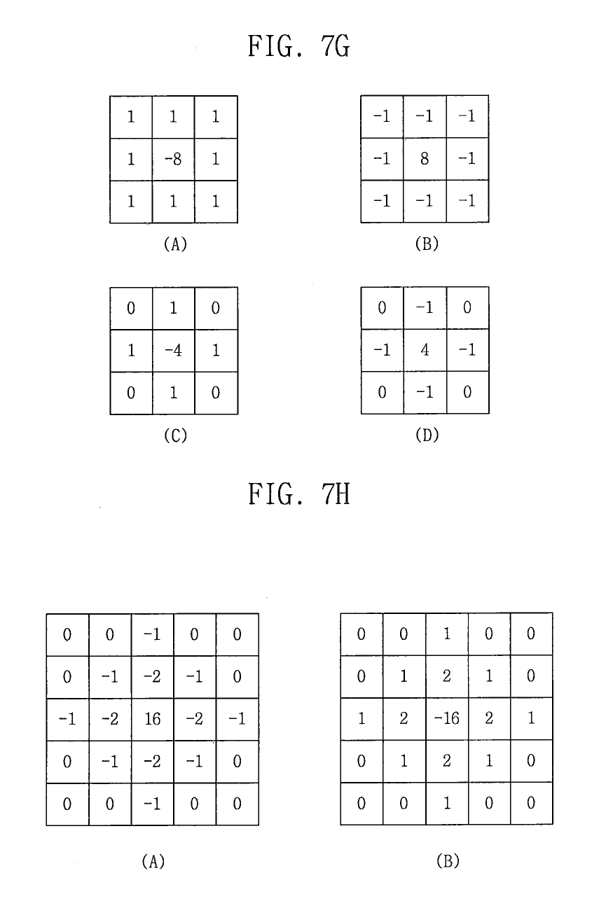

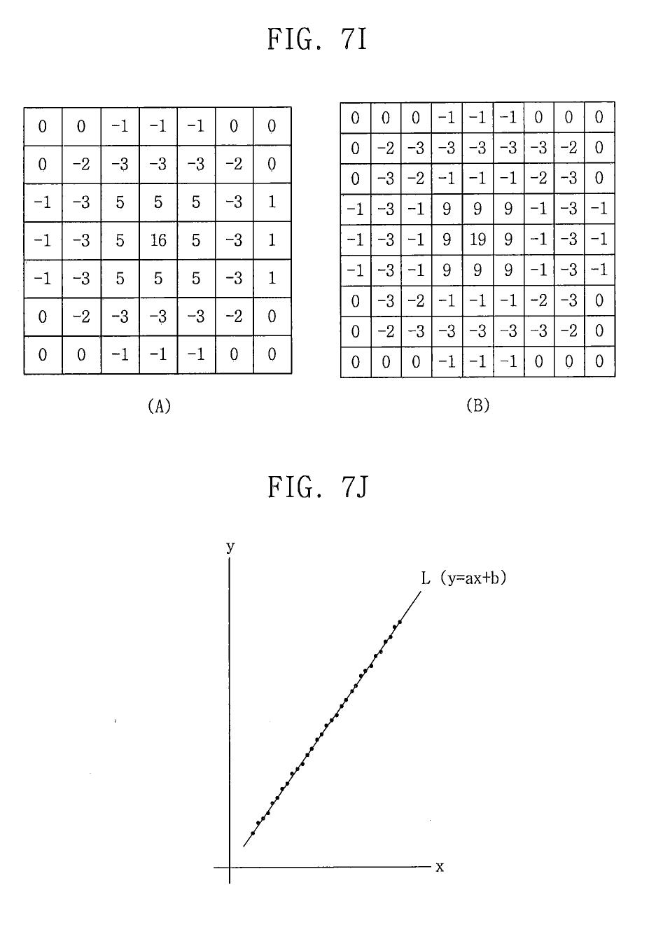

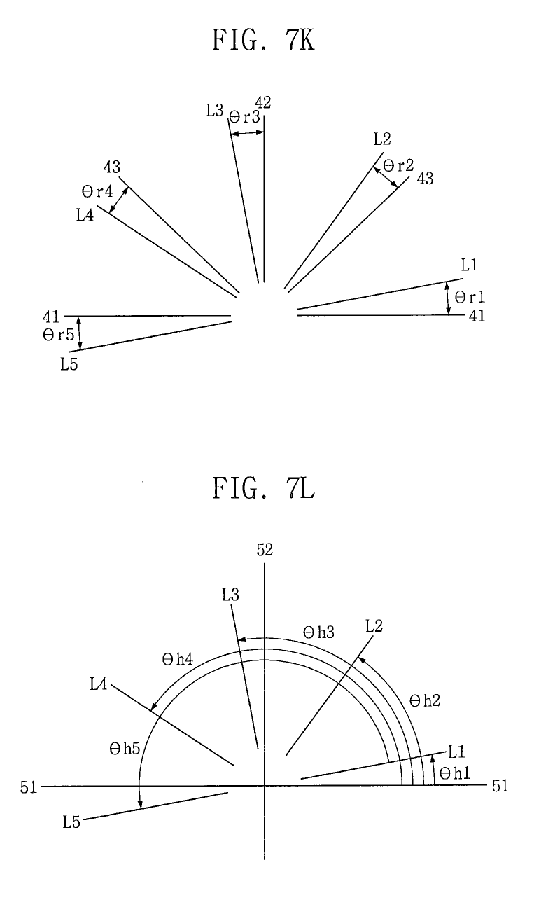

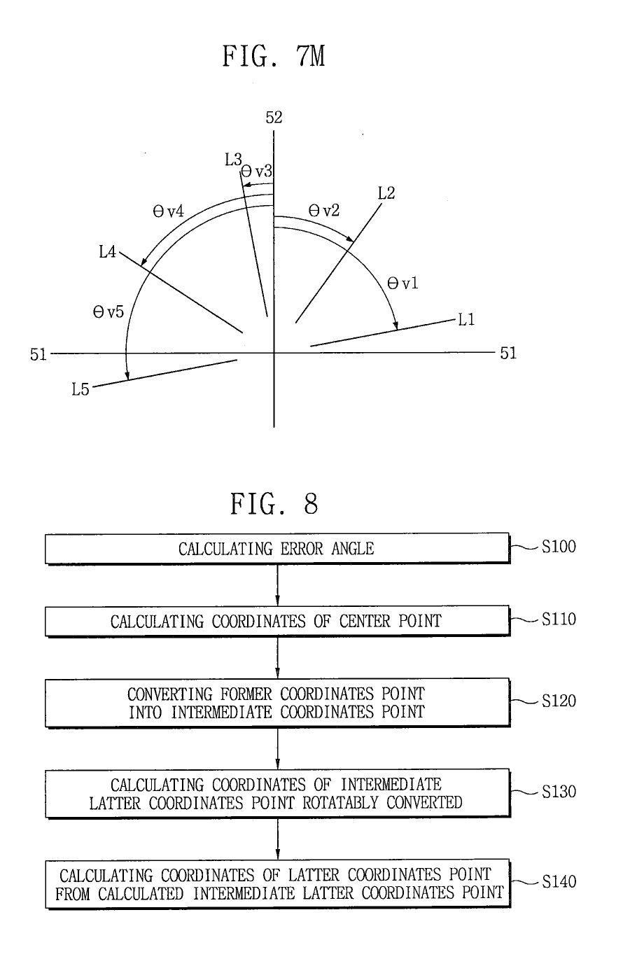

FIG. 6 is a flowchart for conceptually describing a method of measuring a rotation angle according to an embodiment of the inventive concept. FIGS. 7A to 7M are schematic views for conceptually describing a method of measuring the rotation angle.

Referring to FIGS. 6 and 7A, the method of measuring a rotation angle according to an embodiment of the inventive concept may include mounting a wafer 20 on a wafer stage 20S (S10). To easily describe the inventive concept, it is assumed that the wafer 20 is rotationally disposed on the wafer stage 20S to have an error angle Θ. Further, the method of measuring a rotation angle according to the inventive concept may be performed to measure the error angle after the wafer 20 is disposed on the wafer stage 20S.

Referring to FIGS. 6 and 7B, the method of measuring a rotation angle may include obtaining an image of a rotation angle measurement mark 40 formed on the wafer 20 (S20). For example, an image of the rotation angle measurement mark 40 of an alignment key pattern 25 formed in a certain chip region 22 of chip regions 22 on the wafer 20 may be obtained. The image may be obtained using an image obtaining apparatus such as an optical camera or a scanning electron microscope (SEM). As an example, to describe the inventive concept for easy understanding, it is assumed that the rotation angle measurement mark 40 is illustrated to be inclined enough to be visually recognizable. In detail, it is assumed and illustrated that a horizontal line 51 or a vertical line 52 of a cross reference line 50 are not exactly aligned with a horizontal bar 41 or a vertical bar 42 of the rotation angle measurement mark 40 to have an error angle Θ. The cross reference line 50 may be one reference line of a measurement apparatus, a stage, or an image camera.

Referring to FIGS. 6 and 7C, the method of measuring a rotation angle may include a first extraction of edges Eg of the bars 41 to 43 of the rotation angle measurement mark 40 as pixel-level images (S30). In detail, the first extraction may include extracting the edges Eg of the bars 41 to 43 of the rotation angle measurement mark 40 as pixel-level images by calculating the first derivative of a contrast gradient (color) image of the rotation angle measurement mark 40. The edges Eg are portions in which a contrast gradient abruptly changes from a positive value to a negative value or from a negative value to a positive value. Region (A) of FIG. 7C is an enlarged image of a portion of one of the bars 41 to 43 in the rotation angle measurement mark 40. Region (B) of FIG. 7C is a contrast gradient on an arbitrary x-grid xg. Region (C) of FIG. 7C is a graph in which the contrast gradient is differentiated. Accordingly, the method of measuring a rotation angle may include obtaining a contrast gradient for an image of the rotation angle measurement mark 40 on the x-grid xg, calculating the first derivative of the contrast gradient, and a first extraction of edges Eg of the rotation angle measurement mark 40. In FIG. 7C, a process is shown to differentiate a contrast gradient of a horizontal direction (x-direction) of an image of the rotation angle measurement mark 40 and to extract the edges Eg. However, another process may be simultaneously and independently performed to differentiate a gradient for a vertical direction (y-direction) contrast image, and to extract the edges Eg. To describe the inventive concept for easy understanding, the extracting of the edges Eg in the vertical direction (x-direction) is omitted and the extracting of the edges Eg in the horizontal direction (y-direction) is only illustrated.

In consideration of all of the horizontal direction (x-direction) and the vertical direction (y-direction), the edges Eg of the rotation angle measurement mark 40 may be extracted using the following Equations.

Gx=f(x+1,y)−f(x,y) Equation 1

Gy=f(x,y+1)−f(x,y) Equation 2

Where, G is a differentiated gradient, and x and y are row and column coordinates (pixel coordinates), respectively.

Therefore, gradients differentiated in each pixel may be extracted using the following Equations.

$$\begin{matrix}∇ G = \sqrt{{Gx}^{2} + {Gy}^{2}} & Equation 3 \\ ∇ G ≅ \vert Gx \vert + \vert Gy \vert & Equation 4 \\ \begin{matrix}∇ G ( x , y ) = [ \begin{matrix}Gx ( x , y ) \\ Gy ( x , y )\end{matrix} ] \\ = [ \begin{matrix}\frac{\partial f ( x , y )}{\partial x} \\ \frac{\partial f ( x , y )}{\partial y}\end{matrix} ] \\ = [ \begin{matrix}f ( x + 1 , y ) - f ( x , y ) \\ f ( x , y + 1 ) - f ( x , y )\end{matrix} ]\end{matrix} & Equation 5\end{matrix}$$

Referring to FIG. 7D, in another embodiment of the inventive concept, the differentiated gradient (∇G) may be obtained using each contrast of units of 3×3 pixels. For example, the differentiated gradient (∇G) may be obtained using the following Equations.

∇G=\sqrt{(A+B+C−G−H−I)²(A+D+G−C−F−I)²} Equation 6

∇G≅|A+B+C−G−H−I|+|A+D+G−C−F−I| Equation 7

When the above calculation is performed in each unit of pixels, the differentiated gradient (∇G) may be obtained. The edges Eg of the rotation angle measurement mark 40 are illustrated to pass a center pixel E. However, the calculation may be independently performed with respect to all pixels.

Referring to FIG. 7E, the first derivative may be performed using a Sobel mask. That is, the first derivative may include a calculation applying each of 3×3 pixels illustrated in FIG. 7D with a weight factor. The Sobel mask has a better performance in extracting edges extending in a diagonal direction than other masks such as a Roberts mask, a Prewitt mask, and/or the like. Therefore, the inventive concept may include extracting the edges Eg of the rotation angle measurement mark 40 using the Sobel mask. The Sobel mask may include an x-direction detecting mask illustrated in (A) of FIG. 7E and a y-direction detecting mask illustrated in (B) of FIG. 7E. Therefore, the first derivative may include applying the Sobel mask to each pixel in the image of the rotation angle measurement mark 40, calculating each pixel and extracting the edges Eg of the rotation angle measurement mark 40. Coordinates of pixels through which the edges Eg first extracted by the first derivative pass may be obtained. The Sobel mask may include a weight factor of 5×5 pixels. When the size of the mask increases, noise sensitivity decreases, and it becomes difficult to sharply detect edges. Therefore, the inventive concept may include a Sobel mask having 3×3 pixels.

Referring to FIGS. 6 and 7F, the method of measuring a rotation angle may include a second extraction of the edges Eg of the rotation angle measurement mark 40 as sub pixel-level images (S40). The second extraction may include a second derivative of the edges Eg extracted by the first derivative. When the resolution of the extracted edges Eg is not high enough to measure a rotation angle of the rotation angle measurement mark 40, or edges Eg of the rotation angle measurement mark 40 need to be precisely extracted, the second extraction may be required. Otherwise, the second extraction may be omitted. In some embodiments, the first extraction may be omitted and the second derivative may be performed. Image (D) of FIG. 7F shows a graph of one more differential graph which is the derivative of the contrast gradient with further reference to (A) to (C) of FIG. 7C. The second derivative may be performed using a Laplacian operator. For example, the second derivative may be performed using the following Equations.

$$\begin{matrix}{∇}^{2} G = {G}^{2} ( x ) + {G}^{2} ( y ) \\ = \frac{{\partial }^{2} G}{\partial {x}^{2}} + \frac{{\partial }^{2} G}{\partial {x}^{2}} =\end{matrix} \qquad Equation 8$$

Where, since G=f(x,y),

$$\begin{matrix}\begin{matrix}{∇}^{2} G = {∇}^{2} f ( x , y ) \\ = \frac{{\partial }^{2} f ( x , y )}{\partial {x}^{2}} + \frac{{\partial }^{2} f ( x , y )}{\partial {y}^{2}}\end{matrix} & Equation 9 \\ \frac{{\partial }^{2} f ( x , y )}{\partial {x}^{2}} = f ( x + 1 , y ) - 2 f ( x , y ) + f ( x - 1 , y ) \\ and & Equation 10 \\ \frac{{\partial }^{2} f ( x , y )}{\partial {y}^{2}} = f ( x , y + 1 ) - 2 f ( x , y ) + f ( x , y - 1 ) & Equation 11\end{matrix}$$

Therefore,

$$\begin{matrix}{∇}^{2} f ( x , y ) = f ( x + 1 , y ) - 2 f ( x , y ) + f ( x - 1 , y ) + \\ f ( x , y + 1 ) - 2 f ( x , y ) + f ( x , y - 1 ) \\ = f ( x + 1 , y ) + f ( x - 1 , y ) + f ( x , y + 1 ) + \\ f ( x , y - 1 ) - 4 f ( x , y )\end{matrix} \qquad Equation 12$$

Further, after noise is removed using Gaussian smoothing, the second derivative may be performed using a Laplacian of Gaussian (LoG) operator which uses the Laplacian operator.

$$LoG ( x , y ) = \frac{1}{π {σ}^{4}} [ 1 - \frac{{x}^{2} + {y}^{2}}{2 {σ}^{2}} ] - {e}^{\frac{- ( {x}^{2} + {y}^{2} )}{2 {σ}^{2}}} \qquad Equation 13$$

Where, σ is a standard deviation.

FIG. 7G exemplarily shows Laplacian masks having 3×3 pixels. The Laplacian masks may include all weight factors in an x-direction and a y-direction, unlike the Sobel mask.

FIG. 7H exemplarily shows LoG masks having 5×5 pixels.

In some embodiments, the second derivative may be performed using a Difference of Gaussian (DoG) operator. For example, each Gaussian operation may be assigned with a different distribution value, and edges may be extracted using differences of the results of the Gaussian operations. For example, the second derivative may be performed using the following Equation.

$$DoG ( x , y ) = \frac{{e}^{\frac{- ( {x}^{2} + {y}^{2} )}{2 {σ}_{1}^{2}}}}{2 π {σ}_{1}^{2}} - \frac{{e}^{\frac{- ( {x}^{2} + {y}^{2} )}{2 {σ}_{2}^{2}}}}{2 π {σ}_{2}^{2}} . \qquad Equation 14$$

FIG. 7I exemplarily shows DoG masks having 7×7 pixels and 9×9 pixels. The Sobel masks, Laplacian masks, and LoG masks may have weight factors which are vertically symmetrical and/or horizontally symmetrical. The sum of the weight factors is 0 (zero) in each mask.

Coordinates of sub-pixels through which the edges Eg second extracted by the second derivative pass may be obtained. In particular, the extracted edge Eg may be determined to be in a left or right region of a pixel in a horizontal direction (x-direction) and to be in an upper or lower region of a pixel in a vertical direction (y-direction). That is, the edge Eg may be precisely extracted in the resolution of at least one-fourth of a pixel. In some embodiments, a process of the second derivative may be omitted. That is, coordinates of pixels through which edges Eg extracted by the first derivative pass may be directly used in the subsequent process.

Referring to FIGS. 6 and 7J, the method of measuring a rotation angle may include an extraction of regression lines L that pass closest to the sub-pixels using coordinates of sub-pixels through which the second extracted edges pass (S50). That is, the above method may include calculating and extracting regression lines L that pass the sub-pixels using a least square method (LSM). FIG. 7B exemplarily shows the regression line L corresponding to a diagonal bar 43 in a right side region of the rotation angle measurement mark 40. Coordinates of the sub-pixels are conceptually illustrated as dots in FIG. 7J. The regression lines L may be calculated and extracted using the following Equations.

When the coordinates of the sub-pixels may each be (xi, axi+b) and a distance (an error) between the coordinates and the regression lines L is rᵢ,

rᵢ=yᵢ−(axᵢ+b) Equation 15

and,

rᵢ²=yᵢ²−2axᵢyᵢ−2byᵢ+a²xᵢ²+2abxᵢ+b² Equation 16

Therefore,

$${\sum }_{i = 1}^{n} {r}^{2} = \begin{matrix}{nb}^{2} + 2 b ( a {\sum }_{i = 1}^{n} {x}_{i} - {\sum }_{i = 1}^{n} {y}_{i} ) + \\ ( {a}^{2} {\sum }_{i = 1}^{n} {x}_{i}^{2} - 2 a {\sum }_{i = 1}^{n} {x}_{i} {y}_{i} + {\sum }_{i = 1}^{n} {y}_{i}^{2} )\end{matrix} \qquad Equation 17$$

Here, when

$$b = - \frac{a {\sum }_{i = 1}^{n} {x}_{i} - {\sum }_{i = 1}^{n} {y}_{i}}{n} , {\sum }_{i = 1}^{n} {r}^{2}$$

has a minimum value.

Here,

$${\sum }_{i = 1}^{n} {y}_{i} = a {\sum }_{i = 1}^{n} {x}_{i} + nb \qquad Equation 18$$

and,

when the above expression is divided by n,

$$\frac{{\sum }_{i = 1}^{n} {y}_{i}}{n} = a \frac{{\sum }_{i = 1}^{n} {x}_{i}}{n} + b \qquad Equation 19$$

therefore, an average point is on a line y=ax+b.

When rewriting Formula 17 in descending order with respect to a,

$${\sum }_{i = 1}^{n} {r}^{2} = ( {\sum }_{i = 1}^{n} {x}_{i}^{2} ) {a}^{2} + 2 a ( b {\sum }_{i = 1}^{n} {x}_{i} - {\sum }_{i = 1}^{n} {x}_{i} {y}_{i} ) + ( {\sum }_{i = 1}^{n} {y}_{i}^{2} - 2 b {\sum }_{i = 1}^{n} {y}_{i} + {nb}^{2} ) \qquad Equation 20$$

and,

here, when

$$a = - \frac{b {\sum }_{i = 1}^{n} {x}_{i} - {\sum }_{i = 1}^{n} {x}_{i} {y}_{i}}{{\sum }_{i = 1}^{n} {x}_{i}^{2}} , {\sum }_{i = 1}^{n} {r}^{2}$$

has a minimum value.

Here,

$${\sum }_{i = 1}^{n} {x}_{i} {y}_{i} = a {\sum }_{i = 1}^{n} {x}_{i}^{2} + b {\sum }_{i = 1}^{n} {x}_{i} \qquad Equation 21$$

Equations 18 and 21 may determine a and b so that

$${\sum }_{i = 1}^{n} {r}^{2}$$

is minimized.

As described above, in another embodiment, when the second derivative is omitted, the regression lines L may be extracted from coordinates of pixels through which the first extracted edges Eg pass.

Referring to FIGS. 6 and 7K, the method of measuring a rotation angle may include measuring individual error angles Θr1 to Θr5 of regression lines L1 to L5 (S60). Calculation of each of the error angles Θr1 to Θr5 of the regression lines L1 to L5 may include measuring respective horizontal angles Θh1 to Θh5 of the regression lines L1 to L5 from a horizontal line 51 of a cross reference line 50, and calculating individual horizontal error angles Θhr1 to Θhr5 by subtracting respective determined angles (0°, 45°, 90°, 135°, 180°) from the horizontal angles Θh1 to Θh5 (Θhr1=Θh1, Θhr2=Θh2−π/4 (45°), Θhr3=Θhr3−π/2 (90°), Θhr4=Θh4−3π/4 (135°), Θhr5=Θh5−π (180°).

Referring to FIGS. 6 and 7L, the method of measuring a rotation angle may include calculating a representative error angle Θr from the individual error angles Θr1 to Θr5 (S70). Ideally, the regression lines L1 to L5 may be the same as the bars 41 to 43 of the rotation angle measurement mark 40. Accordingly, the individual error angles Θr1 to Θr5 may ideally be identical to each other. Therefore, one of the individual error angles Θr1 to Θr5 may be assumed to be the representative error angle Θr, and the rotation angle may be measured. However, since the regression lines L1 to L5 are graphs in which an image of the rotation angle measurement mark 40 is processed, the regression lines L1 to L5 and the bars 41 to 43 of the rotation angle measurement mark 40 may be inconsistent. Therefore, the method of measuring a rotation angle may include calculating a representative error angle Θr that has a minimum value and the individual error angles Θr1 to Θr5.

For example, the representative error angle Θr may be calculated to have a minimum error value thereof of the respective error angles Θr1 to Θr5 using an LSM.

$$θ r 1 = θ h 1 - θ r , \\ θ r 2 = θ h 2 - \frac{π}{4} - θ r , \\ θ r 3 = θ h 3 - \frac{π}{2} - θ r , \\ θ r 4 = θ h 4 - \frac{3 π}{4} - θ r , and$$

$$θ r 5 = θ h 5 - π - θ r$$

And then,

$$θ r {1}^{2} = {( θ h 1 - θ r )}^{2} , \\ θ r {2}^{2} = {( θ h 2 - \frac{π}{4} - θ r )}^{2} , \\ θ r {3}^{2} = {( θ h 3 - \frac{π}{2} - θ r )}^{2} , \\ θ r {4}^{2} = {( θ h 4 - \frac{3 π}{4} - θ r )}^{2} , and$$

$$θ r {5}^{2} = {( θ h 5 - π - θ r )}^{2}$$

and,

when adding each side,

$${\sum }_{i = 1}^{5} θ {ri}^{2} = {( θ h 1 - θ r )}^{2} + {( θ h 2 - \frac{π}{4} - θ r )}^{2} + {( θ h 3 - \frac{π}{2} - θ r )}^{2} + {( θ h 4 - \frac{3 π}{4} - θ r )}^{2} + {( θ h 5 - π - θ r )}^{2} . \qquad Equation 22$$

Expand and simplify the above,

$$\begin{matrix}{\sum }_{i = 1}^{5} θ {ri}^{2} = {\sum }_{1}^{5} θ {hi}^{2} + 2 θ r {\sum }_{i = 1}^{5} θ hi + 5 θ {r}^{2} - 5 π θ r - π ( \frac{θ h 2}{2} + θ h 3 + \frac{3}{2} θ h 4 + 2 θ h 5 ) & Equation 23 \\ 2 θ r {\sum }_{i = 1}^{5} θ h i + 5 θ {r}^{2} - 5 π θ r = {\sum }_{i = 1}^{5} θ {ri}^{2} + {\sum }_{1}^{5} θ {hi}^{2} - π ( \frac{θ h 2}{2} + θ h 3 + \frac{3}{2} θ h 4 + 2 θ h 5 ) & Equation 24 \\ θ r ( 5 θ r + 2 {\sum }_{i = 1}^{5} θ h i - 5 π ) = {\sum }_{i = 1}^{5} θ {ri}^{2} + {\sum }_{1}^{5} θ {hi}^{2} - π ( \frac{θ h 2}{2} + θ h 3 + \frac{3}{2} θ h 4 + 2 θ h 5 ) & Equation 25\end{matrix}$$

Here, θr may be calculated so that

$${\sum }_{i = 1}^{5} θ {ri}^{2}$$

is to be minimized.

Referring to FIG. 7M, calculation of the individual error angles Θr1 to Θr5 may include measuring respective vertical angles Θv1 to Θv5 of the regression lines L1 to L5 from a vertical line 52 of a cross reference line 50, and calculating respective vertical angles Θvr1 to Θvr5 by subtracting respective determined angles (−90°, −45°, 0°, 45° and 90°) from vertical angles Θv1 to Θv5 (Θvr1=Θv1+π/2 (90°), Θvr2=Θv2+π/4 (45°), Θvr3=Θv3, Θvr4=Θv4−π/4 (45°), Θvr5=Θv5−π/2 (90°)). The determined angles (−90°, −45°, 0°, 45° and 90°) are angles which are composed of the bars 41 to 43 and the vertical line 52. Even here, θr may be calculated so that

$${\sum }_{i = 1}^{5} θ {ri}^{2}$$

is to be minimized using an LSM described with reference to FIG. 7K. Ideally, the horizontal error angles Θhr1 to Θhr5 may be equal to the vertical error angles Θvr1 to Θvr5, respectively. Therefore, the method of measuring a rotation angle may include adding a representative horizontal error angle Θhr to a representative vertical angle Θvr and then dividing it by two, or arithmetically calculating the representative Θr using the horizontal error angles Θhr1 to Θhr5 or the vertical error angles Θvr1 to Θvr5.

$$\begin{matrix}θ r = θ hr = \frac{\sqrt{θ h {1}^{2} + {( θ h 2 - \frac{π}{4} )}^{2} + {( θ h 3 - \frac{π}{2} )}^{2} + {( θ h 4 - \frac{3 π}{4} )}^{2} + {( θ h 5 - π )}^{2}}}{5} = \frac{\sqrt{θ hr {1}^{2} + θ hr {2}^{2} + θ hr {3}^{2} + θ hr {4}^{2} + θ hr {5}^{2}}}{5} & Equation 24 \\ θ r = θ vr = \frac{\sqrt{{( θ v 1 + \frac{π}{2} )}^{2} + {( θ v 2 + \frac{π}{4} )}^{2} + θ v {3}^{2} + {( θ v 4 - \frac{π}{4} )}^{2} + {( θ v 5 - \frac{π}{2} )}^{2}}}{5} = \frac{\sqrt{θ vr {1}^{2} + θ vr {2}^{2} + θ vr {3}^{2} + θ vr {4}^{2} + θ vr {5}^{2}}}{5} & Equation 25 \\ θ r = \frac{\sqrt{θ {hr}^{2} + θ {vr}^{2}}}{2} & Equation 26\end{matrix}$$

As described above, the representative error angles Θr may be calculated using various methods. The representative error angles Θr may be considered as the rotation angle.

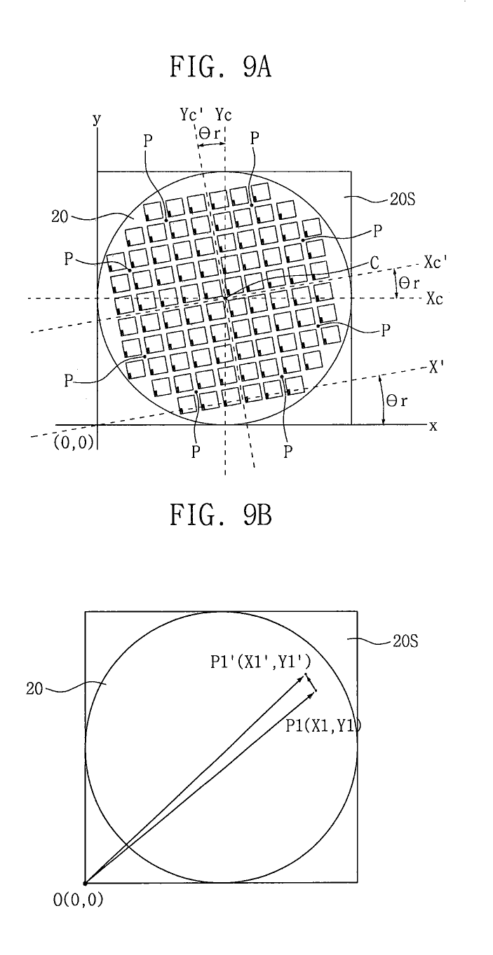

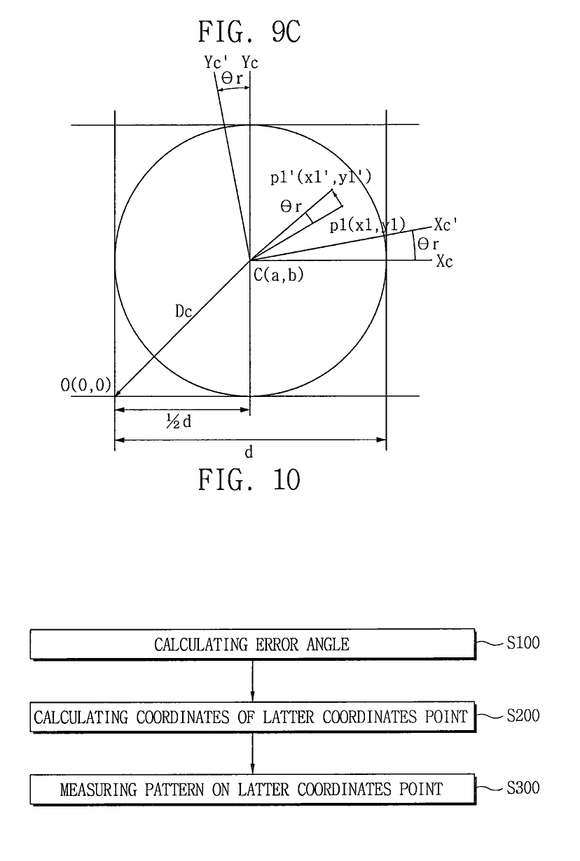

FIG. 8 is a flowchart for conceptually describing a method of tracing coordinates according to an embodiment of the inventive concept. FIGS. 9A to 9C are schematic views for conceptually describing a method of tracing coordinates on a wafer using a rotation angle or an error angle.

First, the method of tracing coordinates according to an embodiment of the inventive concept may include calculating the error angle Θr by a process described with reference to FIGS. 6 and 7A to 7M (S100). Further, the method of tracing coordinates may include using the calculated error angle Θr.

FIG. 9A, with further reference to FIG. 7A, conceptually shows that the wafer 20 is disposed on the wafer stage 20S and rotated as much as an error angle Θr on the basis of a center point C. The wafer stage 20S or the wafer 20 may have virtual center lines Xc and Yc which pass the center point C. Therefore, the wafer 20 may have inclined virtual center lines Xc′ and Yc′ having an error angle Θr. The wafer 20 may include a plurality of coordinate points P. Various patterns for measurement or real patterns may be disposed on the coordinate points P. To describe the inventive concept for easy understanding, it is assumed and described that a side length of the wafer stage 20S is equal to a maximum diameter of the wafer 20. As an example, it is assumed and illustrated that the coordinate points P are formed in scribe lanes between the chip regions 22. In another embodiment, the coordinate points P may be formed in the chip regions 22.

Referring to FIG. 9B, a former point P1 on former coordinates (X1, Y1) may be rotatably moved to a latter point P1′ on latter coordinates (X1′, Y1′). Referring to the former coordinates (X1, Y1), a method of tracing the latter coordinates (X1′, Y1′) will be described.

Referring to FIGS. 8 and 9C, the method of tracing coordinates may include calculating coordinates (a, b) of the center point C (S110). Assuming that a side length of the wafer stage 20S or a maximum diameter of the wafer 20 is d, the coordinates (a, b) of the center point C are the coordinates (d/2, d/2). Further, a distance D_{C} of the center point C from a reference point O is

$$Dc = \frac{1}{2} d \sqrt{2} .$$

As assumed above, the coordinates X1, Y1 of the former coordinate point P1 based on the reference point O will be defined as the following Equations.

P1=C+p1 Equation 27

That is, X1=a+x1 Equation 28

And, Y1=b+y1 Equation 29

The method of tracing coordinates may include converting the former coordinate P1 into an intermediate former point p1 (S120).

The method of tracing coordinates may include calculating coordinates (x1′, y1′) of an intermediate latter point p1′ into which coordinates (x1,y1) of the intermediate former coordinate point p1 is rotatably converted (S130). For example, coordinates (x1′, y1′) of the intermediate latter coordinate point p1′ may be calculated using the following Equation.

$$( \begin{matrix}x {1}^{′} \\ y {1}^{′}\end{matrix} ) = ( \begin{matrix}cos θ r & - sin θ r \\ sin θ r & cos θ r\end{matrix} ) ( \begin{matrix}x 1 \\ y 1\end{matrix} ) \qquad Equation 30$$

The method of tracing coordinates may include calculating coordinates (X1′, Y1′) of the latter coordinate point P1′ from coordinates (x1′,y1′) of the calculated intermediate latter coordinate point p1′ (S140).

Therefore, the coordinates (X1, Y1) of the latter coordinate point P1′ may be calculated as follows.

X1′=a+x1′ Equation 31

Y1′=b+y1′ Equation 32

Coordinates to which a plurality of coordinated points P illustrated in FIG. 9A are rotatably moved may be calculated through the calculation described above.

Subsequently, a process of measuring various patterns for measurement or real patterns on the rotatably moved coordinates may be performed. For example, the method of measuring patterns according to an embodiment of the inventive concept may include a process which is described in the method of measuring a rotation angle and the method of tracing coordinates, and further include a process of measuring various patterns on the rotatably moved coordinates.

FIG. 10 is a flowchart for conceptually describing a method of measuring a pattern according to an embodiment of the inventive concept. Referring to FIG. 10, the method of measuring the pattern according to an embodiment of the inventive concept may include calculating an error angle Θr by performing a process described with reference to FIGS. 6 and 7A to 7M (S100), calculating coordinates of a latter coordinate point by performing a process described with reference to FIGS. 8 and 9A to 9C (S200), and measuring patterns for measurement on the latter coordinate point (S300). The patterns for measurement may include test patterns, a monitoring pattern, alignment keys and/or real patterns.

According to the inventive concept, in the field of a semiconductor manufacturing technology, after the wafer 20 is disposed on the wafer stage 20S, a process of measuring the error angle Θr and measuring various patterns for measurement or real patterns on the measurement point may be rapidly performed. According to an embodiment of the inventive concept, a rotation angle in which a wafer is rotated can be measured by one measuring process. According to an embodiment of the inventive concept, an origin alignment and a rotation angle measurement can be performed by one image shot. According to an embodiment of the inventive concept, a rotation angle in which a wafer is rotated is referred to by one measuring process, and tracing coordinates and measuring patterns can be rapidly performed.

The foregoing is illustrative of embodiments of the inventive concept with reference to the accompanying drawings. Although a number of embodiments have been described, those of ordinary skill in the art will readily understand that many modifications are possible in embodiments without materially departing from the novel teachings and advantages. Therefore, it is to be understood that the foregoing is illustrative of various embodiments and is not to be construed as limiting to the specific embodiments disclosed.

What is claimed is:

1. An alignment key pattern on a substrate, comprising:
an origin alignment mark having a cross shape; and
a rotation angle measurement mark (RAMM) having a radial shape, said RAMM comprising a plurality of radially extending bars that are aligned to a common center point.

2. The alignment key pattern of claim 1, wherein the origin alignment mark includes a vertical bar and a horizontal bar which are orthogonal.

3. The alignment key pattern of claim 1, wherein the origin alignment mark and the rotation angle measurement mark are adjacent to each other to be disposed within a single image shot.

4. The alignment key pattern of claim 1, wherein the origin alignment mark is disposed closer to a corner of a shot region than the rotation angle measurement mark.

5. The alignment key pattern of claim 1, wherein the rotation angle measurement mark includes:
at least two horizontal bars, which extend horizontally and are spaced apart from each other;
a vertical bar configured to be perpendicular to and spaced apart from the horizontal bars; and
diagonal bars configured to have a first angle with respect to and be spaced apart from the horizontal bars and the vertical bar.

6. The alignment key pattern of claim 5, wherein the horizontal bars, the vertical bar and the diagonal bars are disposed in a half-radial or a half-spoke shape within a half-circular region.

7. The alignment key pattern of claim 5, wherein the horizontal bars, the vertical bar, and the diagonal bars are disposed in a radial shape.

8. The alignment key pattern of claim 5, wherein the horizontal bars, the vertical bar and the diagonal bars are spaced apart from each other and do not intersect each other.

9. The alignment key pattern of claim 5, wherein the first angle is 45° (π/4).

10. The alignment key pattern of claim 5, wherein the horizontal bars are disposed on the same virtual line.

11. An alignment key pattern on a substrate, comprising:
a first horizontal bar and a second horizontal bar disposed on the same virtual line and spaced apart from each other on the substrate;
a vertical bar configured to be perpendicular to and spaced apart from the first horizontal bar and the second horizontal bar;
a first diagonal bar disposed between the first horizontal bar and the vertical bar to have a first angle with respect to the first horizontal bar, and spaced apart from the first horizontal bar and the vertical bar; and
a second diagonal bar disposed between the second horizontal bar and the vertical bar to have a second angle with respect to the second horizontal bar, and spaced apart from the second horizontal bar and the vertical bar.

12. The alignment key pattern of claim 11, wherein virtual extending lines of the first horizontal bar, the second horizontal bar, the vertical bar, the first diagonal bar and the second diagonal bar intersect at one point.

13. The alignment key pattern of claim 11, wherein the first angle is equal to the second angle.

14. The alignment key pattern of claim 11, wherein the first angle and the second angle have one value of 15° (π/12), 30° (π/6), and 45° (π/4).

15. The alignment key pattern of claim 11, further comprising an origin alignment mark including a vertical bar and a horizontal bar which are orthogonal to each other.

16. An alignment key pattern on a substrate, comprising:
an origin alignment mark and a rotation angle measurement mark (RAMM) that are adjacent to each other,
wherein the origin alignment mark comprises orthogonally intersected bars having a cross shape, and
the RAMM comprises a horizontal bar, a vertical bar that is perpendicular to the horizontal bar, and a diagonal bar that is inclined to have a first angle with respect to the horizontal bar and the vertical bar.

17. The alignment key pattern of claim 16, wherein the horizontal bar comprises two separate bars that are disposed on the same virtual horizontal line,
the vertical bar is disposed on a virtual vertical line that passes a center between the two separate bars, and
the diagonal bar is disposed on a virtual diagonal line that passes the center between the two separate bars.

18. The alignment key pattern of claim 17, wherein the RAMM further comprises a lower vertical bar that is disposed on the virtual vertical line and is spaced apart from the vertical bar.

19. The alignment key pattern of claim 18, wherein the RAMM further comprises a lower diagonal bar that is disposed between the horizontal bar and the lower vertical bar.

20. The alignment key pattern of claim 16, wherein the diagonal bar comprises at least two diagonal bars that are disposed between the horizontal bar and the vertical bar.
